(19) United States
(12) Patent Application Publication
(10) Pub. No.: US 2020/0307630 A1
(43) Pub. Date: Oct. 1, 2020

(54) VEHICLE CONTROL DEVICE, VEHICLE CONTROL METHOD AND NON-TRANSITORY COMPUTER-READABLE MEDIUM

(71) Applicant: PANASONIC INTELLECTUAL PROPERTY MANAGEMENT CO., LTD., Osaka (JP)

(72) Inventors: Iori UEDA, Kanagawa (JP); Shota AKAURA, Kanagawa (JP); Yuya MATSUMOTO, Tokyo (JP)

(73) Assignee: PANASONIC INTELLECTUAL PROPERTY MANAGEMENT CO., LTD., Osaka (JP)

(21) Appl. No.: 16/831,108

(22) Filed: Mar. 26, 2020

(30) Foreign Application Priority Data
Mar. 29, 2019 (JP) 2019-068794

(51) Int. Cl. B60W 60/00; G08G 1/01

(52) U.S. Cl. CPC B60W 60/0011; G08G 1/0145; B60W 60/0015; B60W 60/0025; G08G 1/0125

(57) ABSTRACT

A vehicle control device includes: a determination unit configured to determine a control condition related to vehicle traveling when a host vehicle, which is a control target vehicle, travels automatically by automatic driving; and a control unit configured to control traveling of the host vehicle based on a determination result of the determination. The determination unit is configured to: acquire a position of the host vehicle; and determine whether to enter an intersection based on a detection result of a stopped vehicle stopped at the intersection when the host vehicle approaches the intersection which is designated to require vehicles on all road segments entering the intersection to stop at a same priority. The control unit is configured to perform travel control of entering and passing through the intersection in accordance with a determination result of the determination unit.

### FIELD

The present disclosure relates to a vehicle control device, a vehicle control method, and a non-transitory computer-readable medium, which are configured to control traveling of a vehicle.

### BACKGROUND

Various travel control devices which control traveling of vehicle, such as vehicle speed, steering and braking, have been proposed. In addition, a vehicle having an automatic driving function, to which such travel control devices are applied, has been proposed. For example, a vehicle control system that controls passage of each vehicle at an intersection has been disclosed as a device for controlling traveling of vehicle, (see JP-A-2006-338596). The vehicle control system according to JP-A-2006-338596 has a configuration in which vehicles approaching the intersection are detected, and a priority related to entry of the intersection is set for each vehicle. As a result, it is possible to achieve smooth and efficient traffic at the intersection.

### SUMMARY

In a case where travel control of a vehicle is performed by automatic driving, as for traveling at an intersection where the same priority is assigned to all road segments entering the intersection, appropriate control is required according to situations, such as presence or absence of other vehicles that enter the intersection.

The present disclosure is devised in view of above-described circumstances, and an object thereof is to provide a vehicle control device, a vehicle control method, and a non-transitory computer-readable medium, which can appropriately control traveling of a vehicle according to situations at an intersection where the same priority is assigned to all road segments entering the intersection.

In the present disclosure, there is provided a vehicle control device configured to control traveling of a vehicle which can be automatically driven, the vehicle control device including: a determination unit configured to determine a control condition related to vehicle traveling when a host vehicle, which is a control target vehicle, travels automatically by automatic driving; and a control unit configured to control traveling of the host vehicle based on a determination result of the determination, wherein the determination unit is configured to: acquire a position of the host vehicle; and determine whether to enter an intersection based on a detection result of a stopped vehicle stopped at the intersection when the host vehicle approaches the intersection which is designated to require vehicles on all road segments entering the intersection to stop at a same priority, and wherein the control unit is configured to perform travel control of entering and passing through the intersection in accordance with a determination result of the determination unit.

In the present disclosure, there is provided a vehicle control method of a vehicle control device configured to control traveling of a vehicle which can be automatically driven, the vehicle control method including: determining a control condition related to vehicle traveling when a host vehicle, which is a control target vehicle, travels automatically by automatic driving; and controlling traveling of the host vehicle based on a determination result of the determination, wherein the determining the control condition includes: acquiring a position of the host vehicle; and determining whether to enter an intersection based on a detection result of a stopped vehicle stopped at the intersection when the host vehicle approaches the intersection which is designated to require vehicles on all road segments entering the intersection to stop at a same priority, and wherein the controlling traveling of the host vehicle includes: performing travel control of entering and passing through the intersection is performed in accordance with a determination result of whether to enter the intersection.

In the present disclosure, there is provided a non-transitory computer-readable medium storing a program, when executed by a computer, causing the computer to perform a vehicle control method for controlling traveling of a vehicle which can be automatically driven, the method including: determining a control condition related to vehicle traveling when a host vehicle, which is a control target vehicle, travels automatically by automatic driving; and controlling traveling of the host vehicle based on a determination result of the determination, wherein the determining the control condition includes: acquiring a position of the host vehicle; and determining whether to enter an intersection based on a detection result of a stopped vehicle stopped at the intersection when the host vehicle approaches the intersection which is designated to require vehicles on all road segments entering the intersection to stop at a same priority, and wherein the controlling traveling of the host vehicle includes: performing travel control of entering and passing through the intersection in accordance with a determination result of whether to enter the intersection.

According to the present disclosure, the traveling of the vehicle can be appropriately controlled according to situations at the intersection where the same priority is assigned to all road segments entering the intersection.

### BRIEF DESCRIPTION OF DRAWINGS

FIG. 1 is a block diagram showing an example of a configuration of a vehicle control device according to an embodiment.

FIG. 2 is a flowchart showing a processing procedure related to travel control of the vehicle control device according to the embodiment.

FIG. 3 is a flowchart showing a processing procedure in a case of all direction simultaneous arrival in the travel control shown in FIG. 2.

FIG. 4 shows a first example of the travel control according to the embodiment (normal case, no simultaneous arrival).

FIG. 5 shows a second example of the travel control according to the embodiment (with simultaneous arrival (two adjacent vehicles), no all direction stop).

FIG. 6 shows a third example of the travel control according to the embodiment (with simultaneous arrival (two facing vehicles), no all direction stop).

FIG. 7 shows a fourth example of the travel control according to the embodiment (with simultaneous arrival (three vehicles) with stopped vehicles, with all direction stop).

FIG. 8 shows a fifth example of the travel control according to the embodiment (with simultaneous arrival (two vehicles) with stopped vehicles, with all direction stop).

FIG. 9 shows a sixth example of the travel control according to the embodiment (all direction simultaneous arrival).

### DETAILED DESCRIPTION

(Knowledge for Achieving the Present Disclosure)

As described above, as for the traveling at the intersection where the same priority is assigned to all road segments entering the intersection, appropriate control is required according to situations, such as presence or absence of other vehicles that enter the intersection.

For example, in the vehicle control system according to JP-A-2006-338596, communication between vehicles (vehicle-vehicle communication) or communication between a vehicle and a device installed on a road side (road-vehicle communication) is performed for vehicles approaching the same priority intersection where no traffic light is installed, then a vehicle closest to the intersection is determined to be a priority vehicle. As a result, it is possible to efficiently pass through the intersection without necessarily stop the priority vehicle.

However, in the example of related art according to JP-A-2006-338596, each vehicle is controlled to decelerate without stopping, thus JP-A-2006-338596 is not targeted for an intersection which is designated to require vehicles on all road segments entering the intersection to stop. The vehicle determined to be the highest priority may be stopped in accordance with traffic rules, while the vehicle having the closest distance from the intersection does not always reach the intersection first due to a difference in vehicle speeds. In this case, even if a vehicle arrives at the intersection first, the vehicle has to wait for the vehicle, which is determined to be the priority, to pass. Moreover, a distance between a vehicle and the intersection is measured by host vehicle position measurement of a navigation system mounted on the vehicle, and is a rough distance indicating whether the vehicle is located within a certain range in consideration of position measurement error of a satellite positioning system. Therefore, accuracy of determination of the vehicle close to the intersection is low, and priority orders of the vehicles cannot be accurately determined. In particular, the appropriate control cannot be performed in a case where an intersection is designated to require vehicles on all road segments entering the intersection to stop at the same priority (i.e., an all-way stop).

Therefore, the present disclosure shows a configuration example of a vehicle control device in which traveling of a vehicle can be appropriately controlled according to situations at an intersection where the same priority is assigned to all road segments entering the intersection.

Hereinafter, embodiments of a vehicle control device, a vehicle control method, and a program according to the present disclosure will be described in detail with reference to the accompanying drawings. However, unnecessarily detailed descriptions may be omitted. For example, a detailed description of a well-known matter or a repeated description of substantially the same configuration may be omitted. This is to avoid unnecessary redundancy in the following description and to facilitate understanding of those skilled in the art. It should be noted that the accompanying drawings and the following description are provided to provide a thorough understanding of the present disclosure by those skilled in the art, and are not intended to limit the subject matter recited in the claims.

In the following embodiment, a configuration example of a device including a vehicle control unit that controls traveling of a vehicle, which can be automatically driven, is shown as an example of the vehicle control device.

(Configuration of Embodiment)

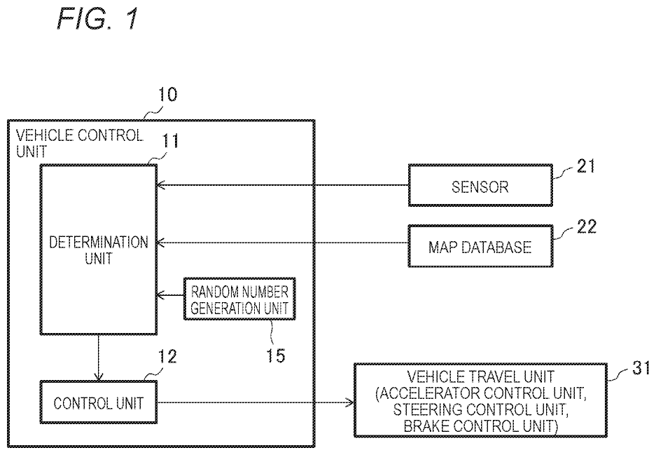

FIG. 1 is a block diagram showing an example of a configuration of the vehicle control device according to the embodiment.

A vehicle control unit 10 is provided, for example, in an ECU (electronic control unit or engine control unit) that controls each unit of a vehicle. The vehicle control unit 10 includes a processor and a memory, and realizes various functions by, for example, executing a predetermined program stored in the memory or storage by the processor. The processor may include a micro processing unit (MPU), a central processing unit (CPU), a digital signal processor (DSP), a graphical processing unit (GPU), and the like. The memory may include a random access memory (RAM), a read only memory (ROM), and the like. The storage may include a hard disk drive (HDD), a solid state drive (SSD), an optical disk device, a memory card, and the like. The vehicle control unit 10 performs travel control when a control target vehicle travels automatically by automatic driving. The vehicle control unit 10 includes a determination unit 11 and a control unit 12 as functional configurations.

The vehicle control unit 10 is connected to a sensor 21, which serves as an information input device, and a map database 22. The sensor 21 includes a light detection and ranging (LiDAR), and acquires sensor detection information such as object detection information around the vehicle. The sensor 21 may include a camera, a satellite positioning system receiver for a positioning system such as a global positioning system (GPS), millimeter wave radar, a gyro, a range finder, and the like. The map database 22 stores map information including road information. The vehicle control unit 10 is connected to a vehicle travel unit 31 which serves as a device to be controlled. The vehicle travel unit 31 includes an accelerator control unit, a steering control unit, a brake control unit, and the like, and controls elements related to vehicle traveling, such as vehicle speed (acceleration, constant speed, and deceleration), steering and braking, so as to perform vehicle traveling.

In the vehicle control unit 10, the determination unit 11 determines a control condition related to the vehicle traveling. The control unit 12 controls the traveling of the vehicle based on a determination result of the determination unit 11. The determination unit 11 acquires a position of a host vehicle. For example, the determination unit 11 uses the sensor detection information acquired by the sensor 21, such as the object detection information, and the map information including the road information stored in the map database 22 to acquire host vehicle position information indicating the position of the host vehicle, road condition information around the vehicle, other vehicle information, obstacle information, and the like. The determination unit 11 determines a control condition for controlling the device to be controlled during the traveling of the vehicle based on the acquired host vehicle position information and the like. The control unit 12 controls the vehicle travel unit 31 according to a determination result of the control condition, and controls the vehicle speed (acceleration, constant speed, deceleration), steering, braking, and the like in the automatic traveling of the vehicle. The vehicle control unit 10 includes a random number generation unit 15 which generates a random number if necessary during the determination of the control condition.

The LiDAR which serves as the sensor 21 can acquire presence or absence of an obstacle (including another vehicle) around the host vehicle, a distance to the obstacle and information of various objects such as a road shoulder, a median strip, a guardrail, and a line on the road (such as a center line or a stop line) as the object detection information. Based on the object detection information acquired by the sensor 21, travel states of the host vehicle and other vehicles which enter an intersection can be recognized.

The determination unit 11 can acquire position information of the host vehicle (host vehicle position information) based on the object detection information from the sensor 21 and the map information of the map database 22. Position detection information provided by the satellite positioning system receiver may be used as auxiliary information in the acquisition of the host vehicle position information. The determination unit 11 can acquire road information (number of lanes, speed limit, and the like) of a currently traveling road, and intersection information (number of road segments entering the intersection, presence or absence of priority paths, and presence or absence of stop) on the basis of the host vehicle position information. Based on the object detection information from the sensor 21, the determination unit 11 can detect positions, traveling speeds, and the like of other vehicles that enter the intersection. Image information provided by the camera may be used as auxiliary information in the detection of the other vehicles that enter the intersection. A position of a stop line, a distance to a vehicle, types of road signs, types of signals, and the like can be recognized based on the image information.

The vehicle control unit 10 according to the present embodiment performs, as the travel control of the vehicle, control related to entry and passage to an intersection. Here, travel control in a case where a plurality of vehicles enter an intersection will be described. The intersection has no traffic light while the intersection is designated to require vehicles on all road segments entering the intersection to stop at the same priority. In the example to be described in the present embodiment, the intersection is an intersection with four-direction road segments on a road of a right-hand traffic system. The same travel control may be performed with the left and right reversed on a road of a left-hand traffic system. In addition to the intersection having the four-direction road segments formed by intersection of two roads, the present disclosure may be applicable to other intersections having three or more road segments similarly, such as a three-way intersection, a five-way intersection or a six-way intersection.

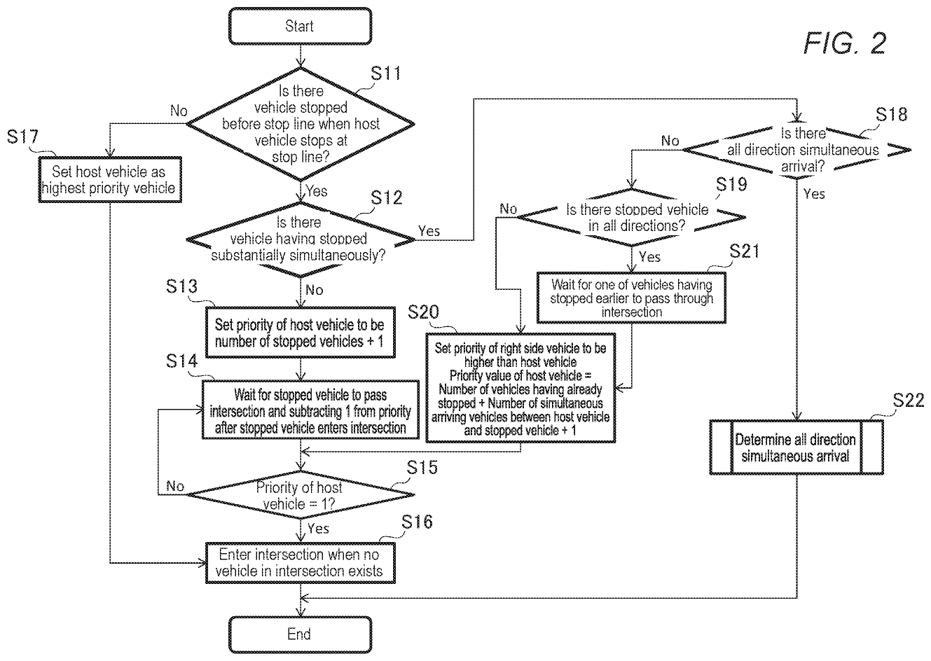

FIG. 2 is a flowchart showing a processing procedure related to the travel control of the vehicle control device according to the embodiment. Processing of travel control related to passage of the intersection performed by the vehicle control unit 10 will be described below.

The determination unit 11 of the vehicle control unit 10 recognizes that the host vehicle is approaching and entering an intersection based on the sensor detection information (object detection information) from the sensor 21 during traveling of the host vehicle. In the following description, an intersection, which is designated to require vehicles on all road segments entering the intersection to stop at the same priority, is targeted as the intersection through which the host vehicle passes. In principle, each vehicle that enters the intersection passes through the intersection in order from a vehicle stopped first at a stop line of the intersection.

The control unit 12 of the vehicle control unit 10 gives a control instruction to the vehicle travel unit 31 to perform deceleration and braking, thus the vehicle speed of the host vehicle is controlled, and the host vehicle is stopped before the stop line of the intersection.

The determination unit 11 of the vehicle control unit 10 sets a priority indicating a priority order of passing through the intersection such that the vehicles pass through the intersection in order from the vehicle stopped first at the intersection, and determines whether to enter the intersection. According to the rule applied in the present embodiment, positive integer values of 1, 2, 3, . . . are used as the priority, the priority of a vehicle which has the highest priority order of passing through the intersection is set to 1, a smaller priority value indicates a higher priority order (priority), and a vehicle having a smaller priority value passes first. In this case, the travel control is performed such that a vehicle whose priority is a minimum value, namely 1, passes through the intersection first.

When the host vehicle stops at the stop line of the currently entering intersection, the determination unit 11 checks whether there is any vehicle stopped before the stop line (a stopped vehicle) in other road segments of the intersection (S11). When there is another vehicle stopped before the stop line, the determination unit 11 determines whether there is a vehicle that has stopped substantially simultaneously (at the same time within a predetermined period), that is, whether there is a plurality of simultaneous arriving vehicles (S12).

Here, in the determination of whether there is any vehicle stopped at the stop line performed in the determination unit 11, the stop may be determined upon detecting that the vehicle speed of a vehicle entering the intersection becomes 0 or a small value near 0 within a range of a predetermined distance from the stop line. The range of the predetermined distance may be, for example, a range of 1 m in front of the stop line to 2 m behind. In the determination of whether there is any vehicle that has stopped simultaneously performed in the determination unit 11, the simultaneous stop may be determined upon detecting that a plurality of vehicles have stopped within a predetermined short period of time. The predetermined short period of time may be 0.5 seconds or less, for example.

In step S12, when there is no vehicle stopped substantially simultaneously at the stop line (simultaneous arriving vehicle), the determination unit 11 sets the priority such that the priority indicating the priority order of the host vehicle equals to the number of stopped vehicles+1 (S13). That is, when there is a stopped vehicle, the determination unit 11 sets the priority indicating the priority order of the host vehicle to be larger than that of the stopped vehicle. For example, when one other vehicle has already stopped at the time when the host vehicle is stopped, the priority (priority order) of the host vehicle is 1+1=2. In this case, the priority of the stopped vehicle that has stopped earlier is 1, which is the minimum value. In this way, when there is a stopped vehicle, the travel control is performed such that the host vehicle enters the intersection after the stopped vehicle. An example of the specific travel control in this case will be described in a first example which will be described below.

Next, the determination unit 11 waits for the stopped vehicle that has stopped (a vehicle having a higher priority) to pass through the intersection. At this time, the determination unit 11 decreases the priority value by subtracting 1 from the priority of the host vehicle upon recognizing that the stopped vehicle enters and passes the intersection (S14). Then, the determination unit 11 determines whether the priority of the host vehicle is 1, which is the minimum value (S15). Here, when the priority of the host vehicle is 2 or more, the processing of steps S14 and S15 are repeatedly performed until the priority of the host vehicle becomes 1, which is the minimum value, and the host vehicle waits for other vehicles that have stopped earlier and have high priorities to pass through the intersection.

When the priority of the host vehicle is 1, which is the minimum value in step S15, the determination unit 11 determines whether there is any vehicle passing in the intersection, and outputs a determination result of entering the intersection when there is no other vehicle in the intersection (S16). At this time, the determination unit 11 outputs the determination result of entering the intersection to the control unit 12 when passage of other vehicles is not detected, and causes the control unit 12 to perform control to enter and pass through the intersection. The control unit 12 transmits an intersection entry control instruction to the vehicle travel unit 31 in accordance with the determination result of the control condition provided by the determination unit 11, starts traveling, passes the intersection and performs travel control to pass the intersection toward a target direction.

When there is no other vehicle stopped before the stop line in step S11, the priority of the host vehicle is set to 1, which is the minimum value, and the host vehicle is set as a highest priority vehicle (S17). Then the determination unit 11 determines whether there is any vehicle passing in the intersection, and outputs the determination result of entering the intersection when there is no other vehicle in the intersection (S16). Upon receiving the determination result of entering the intersection from the determination unit 11, the control unit 12 gives the intersection entry control instruction to the vehicle travel unit 31 to start the vehicle, and starts traveling of the host vehicle to pass through the intersection.

On the other hand, when there are simultaneous arriving vehicles on the stop line in step S12, the determination unit 11 determines whether the plurality of vehicles that have stopped substantially simultaneously are stopped simultaneously in all directions, that is, whether there is all direction simultaneous arrival (S18). Here, when there is no all direction simultaneous arrival, the determination unit 11 determines whether there is any stopped vehicle in all directions (all direction stop), that is, whether there is any vehicle that has stopped earlier in the road segments of all directions other than the simultaneous arriving vehicle (S19). When there is no stopped vehicle in all directions, the determination unit 11 sets the priority such that the priority of a vehicle located at the intersection from the host vehicle to the right in a priority direction (right side vehicle) is higher than that of the host vehicle (S20). That is, the priority value is set such that the priority value of the host vehicle is equal to the number of stopped vehicles that has already stopped+the number of the simultaneous arriving vehicles between the host vehicle and the stopped vehicle as viewed from the right side+1. For example, when the host vehicle and the right side vehicle stop simultaneously while there is one stopped vehicle that has already stopped, the priority of the stopped vehicle is 1, the priority of the simultaneous arriving right side vehicle is 2, and the priority value of the host vehicle is 1+1+1=3. In this way, when there is a simultaneous arriving vehicle, the travel control is performed such that the host vehicle enters the intersection later than other stopped vehicles including the stopped vehicle that has stopped earlier at the intersection and the simultaneous arriving vehicle located between the host vehicle and the stopped vehicle in the priority direction. In a case where the intersection is an intersection of a left-hand traffic road, the priority direction is on the left side, and the same travel control may be performed with the left and right reversed to prioritize a left side vehicle. Examples of the specific travel control in these cases will be described in a second example and a third example which will be described below.

When there are stopped vehicles in all directions in step S19, the determination unit 11 waits for one of the stopped vehicles that have stopped earlier (a vehicle having the highest priority) to pass through the intersection (S21). Then, in the same manner as described above, the processing proceeds to step S20, in which the determination unit 11 sets the priority such that the priority of the right side vehicle is higher than that of the host vehicle in the case of the right-hand traffic. In the case of the left-hand traffic, the priority of a left side vehicle is higher. Examples of the specific travel control in these cases will be described in a fourth example and a fifth example which will be described below.

After setting the priority of the host vehicle in step S20, the determination unit 11 proceeds to the processing of step S15 and determines whether the priority of the host vehicle is 1, which is the minimum value. Here, when the priority of the host vehicle is 2 or more, the processing of steps S14 and S15 are repeatedly performed until the priority of the host vehicle becomes 1, which is the minimum value, and the host vehicle waits for other vehicles that have stopped earlier and have high priorities to pass through the intersection. When the priority of the host vehicle is 1, the processing proceeds to step S16, the determination unit 11 determines whether there is any vehicle passing in the intersection, and outputs a determination result of entering the intersection when there is no other vehicle in the intersection. Upon receiving the determination result of entering the intersection from the determination unit 11, the control unit 12 gives the intersection entry control instruction to the vehicle travel unit 31 to start the vehicle, and starts traveling of the host vehicle to pass through the intersection.

On the other hand, when there is all direction simultaneous arrival in step S18, all direction simultaneous arrival determination processing is performed (S22). Even in a case where there is no stopped vehicle that has already stopped while a vehicle is stopped simultaneously in a road segment in a facing direction, that is, in a case where two vehicles that face each other are simultaneous arriving vehicles, the same processing as that in the case of the all direction simultaneous arrival may be performed.

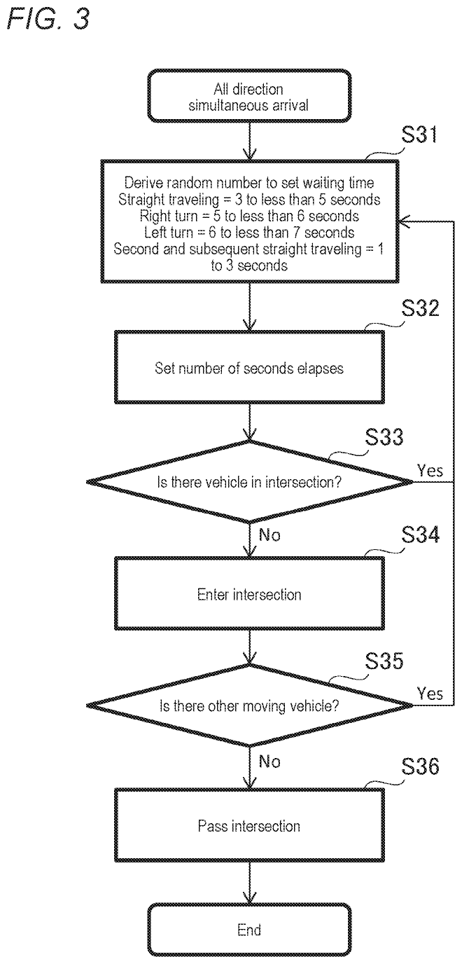

FIG. 3 is a flowchart showing a processing procedure in the case of the all direction simultaneous arrival in the travel control shown in FIG. 2. In FIG. 3, the determination processing performed at the time of the all direction simultaneous arrival in step S22 of FIG. 2 will be described.

When an all direction simultaneous arrival event occurs at the intersection, the determination unit 11 uses a random number randomly generated by the random number generation unit 15 to set a waiting time in accordance with a traveling direction of the host vehicle at the intersection (S31). The determination unit 11 causes the random number generation unit 15 to generate the random number when the all direction simultaneous arrival is determined. The random number generation unit 15 inputs the generated random number to the determination unit 11. The determination unit 11 derives a predetermined period of waiting time based on the input random number. In the present embodiment, straight traveling is prioritized, thus the waiting time is shorter in the case of the straight traveling, and the waiting time is set to be longer in the order of straight traveling<right turn<left turn. As a result, it is possible to set the priority such that the priority value becomes larger in the order of straight traveling<right turn<left turn, that is, the priority order is the order of straight traveling—right turn—left turn.

In a case of passing the intersection by straight traveling, the determination unit 11 derives the waiting time in a range of 3 to less than 5 seconds. In a case of passing the intersection by right turn, the determination unit 11 derives the waiting time in a range of 5 to less than 6 seconds. In a case of passing the intersection by left turn, the determination unit 11 derives the waiting time in a range of 6 to less than 7 seconds. In second and subsequent waiting time setting processing, the determination unit 11 derives the waiting time in a range of 1 to less than 3 seconds in the case of straight traveling.

Next, the determination unit 11 waits until the set number of seconds of the derived waiting time elapses (S32). After the set number of seconds of waiting time elapses, the determination unit 11 determines whether there is any vehicle in the intersection, that is, whether any other vehicle is entering and passing the intersection (S33). When there is a vehicle in the intersection, the determination unit 11 sets the waiting time and waits again (S31, S32). On the other hand, when there is no vehicle in the intersection, the determination unit 11 outputs the determination result of entering the intersection (S34). Upon receiving the determination result of entering the intersection from the determination unit 11, the control unit 12 gives the control instruction to the vehicle travel unit 31 to start the vehicle, and starts traveling of the host vehicle.

Then, the determination unit 11 determines whether there is any other vehicle moving in the intersection (S35). When there is another moving vehicle, the determination unit 11 stops the traveling, sets the waiting time and waits again (S31, S32). On the other hand, when there is no other moving vehicle, the determination unit 11 outputs a determination result of passing the intersection, then the travel control is performed to continue the traveling and pass through the intersection (S36). Upon receiving the determination result of passing the intersection from the determination unit 11, the control unit 12 gives the control instruction to the vehicle travel unit 31 to continue the traveling, and causes the host vehicle to travel along any one of a straight traveling route, a right turn route, and a left turn route to pass the intersection. An example of the specific travel control in this case will be described in a sixth example which will be described below.

Hereinafter, some examples of the specific travel control at the time of entering the intersection in the present embodiment will be described.

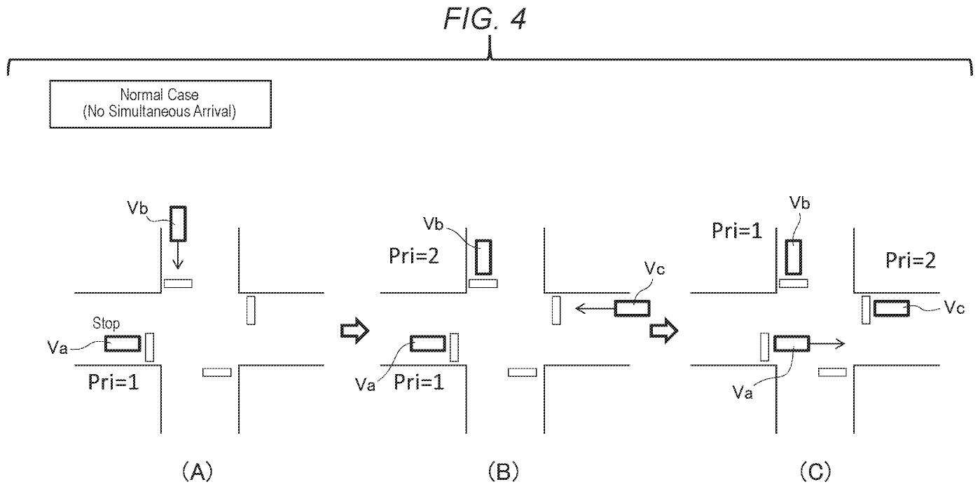

FIG. 4 shows the first example of the travel control according to the embodiment (normal case, no simultaneous arrival). The first example of the travel control is an example corresponding to the processing of step S13 in FIG. 2, and shows a case where there is no simultaneous arriving vehicle in the intersection.

In the intersection, a first vehicle Va has already stopped at the stop line, and then a second vehicle Vb enters the intersection (see (A) of FIG. 4). At this time, the first vehicle Va sets a priority Pri of itself to be Pri=1. Then, the second vehicle Vb stops at the stop line, and subsequently a third vehicle Vc enters the intersection (see (B) of FIG. 4). At this time, the second vehicle Vb sets the priority Pri of itself to be the number of stopped vehicles (1)+1, which makes Pri=1+1=2. Then, the third vehicle Vc stops at the stop line (see (C) of FIG. 4). At this time, since the priority of the first vehicle Va is 1, which is the minimum value, the first vehicle Va confirms that there is no other vehicle in the intersection, then enters and passes the intersection. The priority of the second vehicle Vb is reduced by 1 since the first vehicle Va has passed, which makes Pri=2-1=1. The third vehicle Vc sets the priority Pri of itself to be the number of stopped vehicles (1)+1, which makes Pri=1+1=2. Thereafter, by continuing the same processing, the first vehicle Va, the second vehicle Vb, and the third vehicle Vc pass through the intersection in this order.

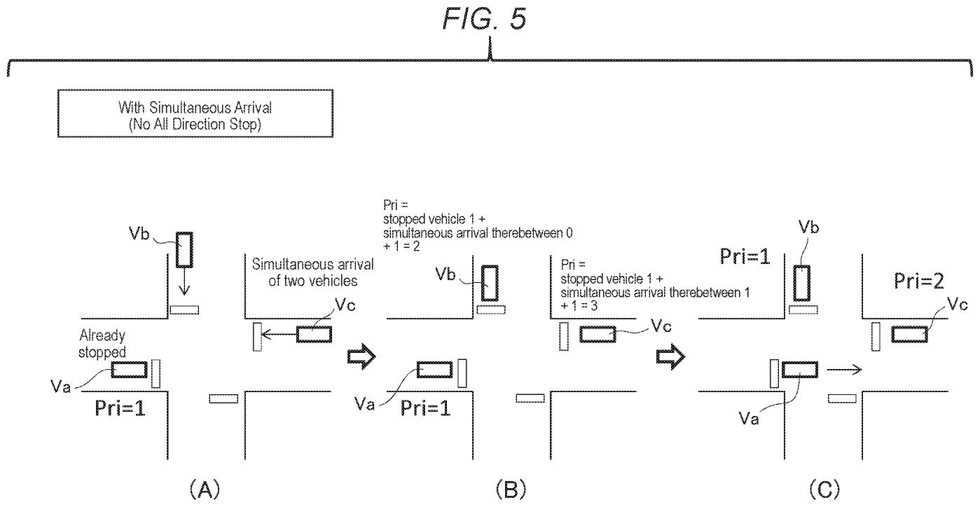

FIG. 5 shows the second example of the travel control according to the embodiment (with simultaneous arrival (two adjacent vehicles), no all direction stop). The second example of the travel control is an example corresponding to the processing of step S20 in FIG. 2, and shows a case where there are simultaneous arriving vehicles in the intersection, and the simultaneous arriving vehicles are in adjacent road segments while there is no stopped vehicle in all directions.

In the intersection, the first vehicle Va has already stopped at the stop line, then the second vehicle Vb and the third vehicle Vc enter the intersection in adjacent road segments (see (A) of FIG. 5). At this time, the first vehicle Va sets the priority of itself to be Pri=1. Then, the second vehicle Vb and the third vehicle Vc are stopped substantially simultaneously at the stop lines of the adjacent road segments (see (B) of FIG. 5). At this time, the second vehicle Vb sets the priority Pri of itself to be the number of stopped vehicles (1)+the number of simultaneous arriving vehicles in the priority direction (right side) between the second vehicle Vb and the stopped vehicle (0)+1, which makes Pri=1+0+1=2. Since the second vehicle Vb is between the third vehicle Vc and the stopped vehicle on the right side of the third vehicle Vc, the third vehicle Vc sets the priority Pri of itself to be the number of stopped vehicles (1)+the number of simultaneous arriving vehicles in the priority direction (right side) between the third vehicle Vc and the stopped vehicle (1)+1, which makes Pri=1+1+1=3.

Since the priority of the first vehicle Va is 1, which the minimum value, the first vehicle Va confirms that there is no other vehicle in the intersection, then enters and passes the intersection (see (C) of FIG. 5). The priority of the second vehicle Vb is reduced by 1 since the first vehicle Va has passed, which makes Pri=2−I=1. The priority of the third vehicle Vc is reduced by 1 since the first vehicle Va has passed, which makes Pri=3-1=2. Thereafter, by continuing the same processing, the first vehicle Va, the second vehicle Vb, and the third vehicle Vc pass through the intersection in this order.

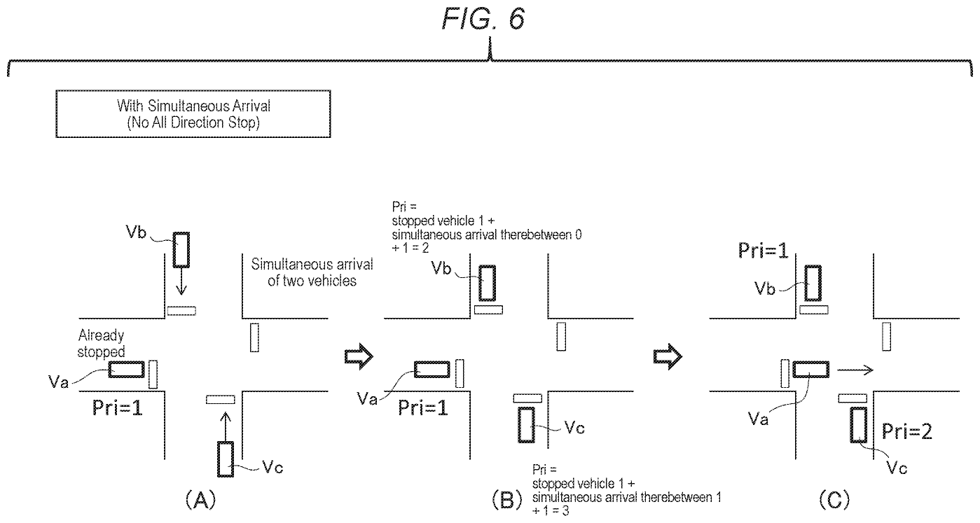

FIG. 6 shows the third example of the travel control according to the embodiment (with simultaneous arrival (two facing vehicles), no all direction stop). The third example of the travel control is an example corresponding to the processing of step S20 in FIG. 2, and shows a case where there are simultaneous arriving vehicles in the intersection, and the simultaneous arriving vehicles are in road segments facing each other while there is no stopped vehicle in all directions.

In the intersection, the first vehicle Va has already stopped at the stop line, then the second vehicle Vb and the third vehicle Vc enter the intersection in road segments which face each other (see (A) of FIG. 6). At this time, the first vehicle Va sets the priority of itself to be Pri=1. Then, the second vehicle Vb and the third vehicle Vc are stopped substantially simultaneously at the stop lines of the road segments which face each other (see FIG. (B) of 6). At this time, similarly to the second example, the second vehicle Vb sets the priority of itself to be Pri=I+0+1=2. Since the second vehicle Vb is between the third vehicle Vc and the stopped vehicle on the right side of the third vehicle Vc, the third vehicle Vc sets the priority Pri of itself to be Pri=1+1+1=3.

Since the priority of the first vehicle Va is 1, which the minimum value, the first vehicle Va confirms that there is no other vehicle in the intersection, then enters and passes the intersection (see (C) of FIG. 6). The priority of the second vehicle Vb is reduced by 1 since the first vehicle Va has passed, which makes Pri=2−1=1. The priority of the third vehicle Vc is reduced by 1 since the first vehicle Va has passed, which makes Pri=3−1=2. Thereafter, by continuing the same processing, the first vehicle Va, the second vehicle Vb, and the third vehicle Vc pass through the intersection in this order.

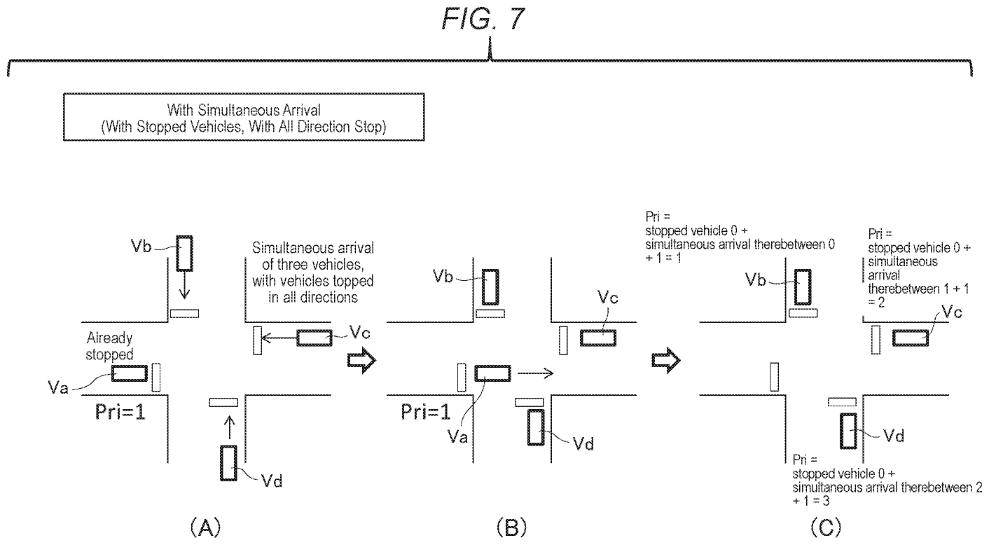

FIG. 7 shows the fourth example of the travel control according to the embodiment (with simultaneous arrival (three vehicles) with stopped vehicles, with all direction stop). The fourth example of the travel control is an example corresponding to the processing of steps S21→S20 in FIG. 2, and shows a case where there are simultaneous arriving vehicles in the intersection, and there are three simultaneous arriving vehicles in other road segments in addition to one stopped vehicle while there are stopped vehicles in all directions.

In the intersection, the first vehicle Va has already stopped at the stop line, then the second vehicle Vb, the third vehicle Vc and a fourth vehicle Vd enter the intersection in other three road segments and stop at the stop lines substantially simultaneously (see (A) of FIG. 7). At this time, the first vehicle Va sets the priority of itself to be Pri=1. In addition, the second vehicle Vb, the third vehicle Vc, and the fourth vehicle Vd wait for the stopped vehicle which has stopped earlier to pass the intersection. Since the priority of the first vehicle Va is 1, which the minimum value, the first vehicle Va confirms that there is no other vehicle in the intersection, then enters and passes the intersection (see (B) of FIG. 7). Then, the priority of each of the three simultaneous arriving vehicles is set such that the priority of the vehicle located on the right side in the priority direction is higher.

At this time, the second vehicle Vb sets the priority Pri of itself to be the number of stopped vehicles (0)+the number of simultaneous arriving vehicles in the priority direction (right side) between the second vehicle Vb and the stopped vehicle (0)+1, which makes Pri=0+0+1=1. Since the second vehicle Vb is on the right side of the third vehicle Vc, the third vehicle Vc sets the priority Pri of itself to be the number of stopped vehicles (0)+the number of simultaneous arriving vehicles in the priority direction (right side) between the third vehicle Vc and the stopped vehicle (1)+1, which makes Pri=0+1+1=2. Since the second vehicle Vb and the third vehicle Vc are on the right side of the fourth vehicle Vd, the fourth vehicle Vd sets the priority Pri of itself to be the number of stopped vehicles (0)+the number of simultaneous arriving vehicles in the priority direction (right side) between the fourth vehicle Vd and the stopped vehicle (2)+1, which makes Pri=0+2+I=3 (see (C) of FIG. 7). Thereafter, by continuing the same processing, the first vehicle Va, the second vehicle Vb, the third vehicle Vc and the fourth vehicle Vd pass through the intersection in this order.

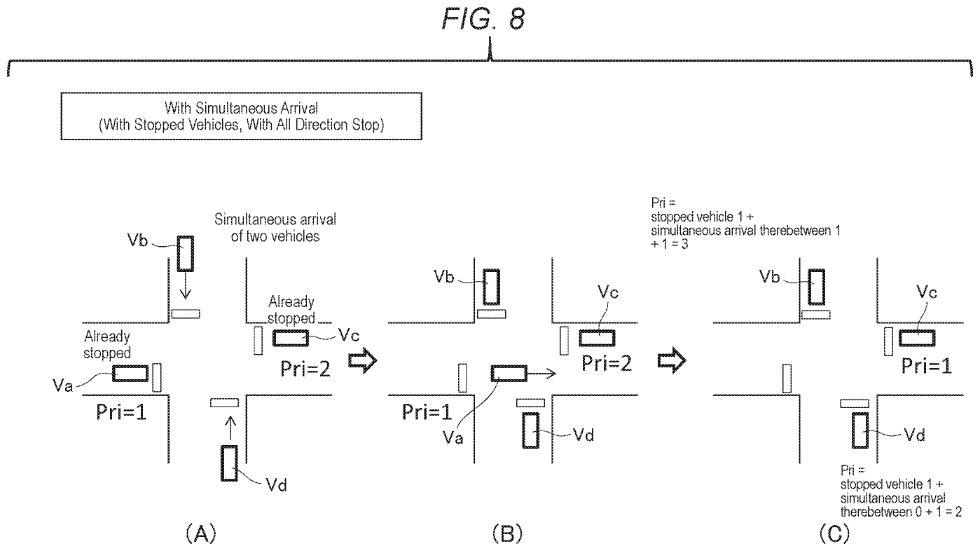

FIG. 8 shows the fifth example of the travel control according to the embodiment (with simultaneous arrival (two vehicles) with stopped vehicles, with all direction stop). The fifth example of the travel control is an example corresponding to the processing of steps S21→S20 in FIG. 2, and shows a case where there are simultaneous arriving vehicles in the intersection, and there are two simultaneous arriving vehicles in other road segments in addition to two stopped vehicle while there are stopped vehicles in all directions.

In the intersection, the first vehicle Va and the third vehicle Vc have already stopped at the stop line, then the second vehicle Vb and the fourth vehicle Vd enter the intersection in other two road segments and stop at the stop lines substantially simultaneously (see (A) of FIG. 8). At this time, it is assumed that the first vehicle Va sets the priority of itself to be Pri=1, and the third vehicle Vc sets the priority of itself to be Pri=2. Since the priority of the first vehicle Va is 1, which the minimum value, the first vehicle Va confirms that there is no other vehicle in the intersection, then enters and passes the intersection. In addition, the second vehicle Vb, the third vehicle Vc, and the fourth vehicle Vd wait for the stopped vehicle which has stopped earlier to pass the intersection (see (B) of FIG. 8). Then, the priority of each of the two simultaneous arriving vehicles is set such that the priority of the vehicle located on the right side in the priority direction is higher.

At this time, the third vehicle Vc which has stopped earlier reduces the priority of itself by 1, which makes Pri=2-1=1. Since the fourth vehicle Vd is on the right side of the second vehicle Vb, the second vehicle Vb sets the priority Pri of itself to be the number of stopped vehicles (1)+the number of simultaneous arriving vehicles in the priority direction (right side) between the second vehicle Vb and the stopped vehicle (1)+1, which makes Pri=I+1+I=3. The fourth vehicle Vd sets the priority Pri of itself to be the number of stopped vehicles (1)+the number of simultaneous arriving vehicles in the priority direction (right side) between the fourth vehicle Vd and the stopped vehicle (0)+1, which makes Pri=1+0+1=2 (see (C) of FIG. 8). Thereafter, by continuing the same processing, the first vehicle Va, the third vehicle Vc, the fourth vehicle Vd and the second vehicle Vb pass through the intersection in this order.

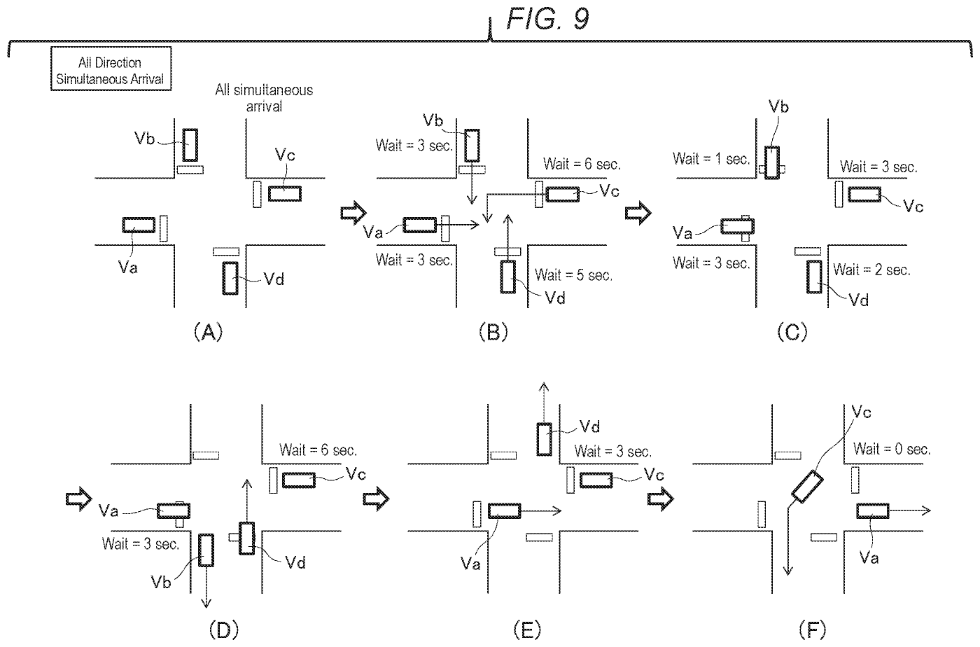

FIG. 9 shows the sixth example of the travel control according to the embodiment (all direction simultaneous arrival). The sixth example of the travel control is an example corresponding to the processing of step S22 in FIG. 2 and FIG. 3, and shows a case where four vehicles arrive simultaneously in all directions in the intersection.

In the intersection, the first vehicle Va, the second vehicle Vb, the third vehicle Vc and the fourth vehicle Vd enter the intersection, stop at the stop lines substantially simultaneously and arrive simultaneously in all road segments (see (A) of FIG. 9). At this time, random numbers are used to set the waiting time for each vehicle. Since each of the first vehicle Va, the second vehicle Vb, and the fourth vehicle Vd travel straight, the waiting time thereof is set within the range of 3 to less than 5 seconds. In the shown example, the waiting time for the first vehicle Va is three seconds, the waiting time for the second vehicle Vb is three seconds, and the waiting time for the fourth vehicle Vd is 5 seconds. Since the third vehicle Vc is to turn left, the waiting time thereof is set within the range of 6 to less than 7 seconds. In the shown example, the waiting time for the third vehicle Vc is set to 6 seconds (see (B) of FIG. 9).

Then, after a lapse of 3 seconds, the waiting time of the first vehicle Va and the second vehicle Vb becomes 0 and the vehicles are started. In this case, since there is another moving vehicle, each of the first vehicle Va and the second vehicle Vb sets the waiting time again in the range of 1 to less than 3 seconds. In the shown example, the waiting time for the first vehicle Va is three seconds, the waiting time for the second vehicle Vb is one second. At this time, the waiting time of the third vehicle Vc is 3 seconds, and the waiting time of the fourth vehicle Vd is 2 seconds (see (C) of FIG. 9).

Then, after a lapse of one second from the state of (C) of FIG. 9, the waiting time of the second vehicle Vb becomes 0, and the second vehicle Vb enters and passes the intersection since there is no other started vehicle. After a lapse of two seconds from the state of (C) of FIG. 9, the waiting time of the fourth vehicle Vd becomes 0, and the fourth vehicle Vd enters and passes the intersection since there is no other started vehicle. After a lapse of three seconds from the state of (C) of FIG. 9, the waiting time of each of the first vehicle Va and the third vehicle Vc becomes 0, and the vehicles are started. However, since there is another moving vehicle, the waiting time for the first vehicle Va is set again in the range of 1 to less than 3 seconds while the waiting time of the third vehicle Vc is set again in the range of 6 to less than 7 seconds since the third vehicle is to turn left. In the shown example, the waiting time for the first vehicle Va is three seconds, the waiting time for the third vehicle Vc is six seconds (see FIG. 9).

Then, after a lapse of three seconds from the state of (D) of FIG. 9, the waiting time of the first vehicle Va becomes 0, and the first vehicle Va enters and passes the intersection since there is no other started vehicle. At this time, the waiting time of the third vehicle Vc is 3 seconds (see (E) of FIG. 9). After a lapse of three seconds from the state of (E) of FIG. 9, the waiting time of the third vehicle Vc becomes 0, and the third vehicle Vc enters and passes the intersection since there is no other started vehicle (see (F) of FIG. 9). As described above, the second vehicle Vb, the fourth vehicle Vd, the first vehicle Va and the third vehicle Vc pass through the intersection in this order.

According to the present embodiment, when the control target vehicle travels automatically by automatic driving, appropriate control can be performed depending on situations in a case where the control target vehicle approaches and enters an intersection which is designated to require vehicles on all road segments entering the intersection to stop at the same priority. For example, the priority of the host vehicle can be set in accordance with states of vehicles stopped in each road segment of the intersection, such as presence or absence or the number of stopped vehicles that have stopped earlier, the number of simultaneous arriving vehicles in the priority direction and all direction simultaneous arrival, and the traveling control of a vehicle can be appropriately performed by automatic driving at an intersection.

For example, the priority is set in order from the vehicle stopped first at the intersection, so that the priority of the vehicle can be determined with high accuracy without being influenced by position measurement error of a satellite positioning system or the like. As a result, the priority can be appropriately set according to situations of each vehicle entering the intersection, and thus each vehicle can smoothly pass the intersection. The traveling can be controlled by appropriately setting the priority without using communication such as vehicle-vehicle communication with other vehicles and road-vehicle communication with devices on the road. In this case, a function of performing automatic travel control at the intersection can be configured at a low cost by practical means. Therefore, even when there are vehicles that do not have vehicle-vehicle communication and road-vehicle communication functions at the intersection, or when there are manually-driven vehicles, the priority can be set independently and appropriately for automatic driven vehicles and thus the vehicles can smoothly travel in the intersection. Therefore, each vehicle including the automatically-driven vehicles can smoothly pass the intersection which is designated to require vehicles on all road segments entering the intersection to stop at the same priority.

As described above, the vehicle control device, the vehicle control method, and the program according to the present embodiment control the traveling of the vehicle that can be automatically driven, and include, for example, the vehicle control unit 10 which includes the processor and the memory. The vehicle control unit 10 includes the determination unit 11, which determines the control condition related to the vehicle traveling when the host vehicle serving as the control target vehicle travels automatically by the automatic driving, and the control unit 12 which controls the traveling of the host vehicle based on the determination result of the determination unit 11. The determination unit 11 acquires the position of the host vehicle. For example, the determination unit 11 acquires the sensor detection information around the host vehicle detected by the sensor 21 and the map information, and acquires the position of the host vehicle based on the sensor detection information and the map information. The determination unit 11 determines whether to enter the intersection based on the detection result of the stopped vehicle stopped at the intersection when the host vehicle approaches the intersection which is designated to require vehicles on all road segments entering the intersection to stop at the same priority. For example, the determination unit 11 detects the stopped vehicle stopped at the intersection based on the sensor detection information. The determination unit 11 may set the priority indicating the priority order of passing through the intersection, and determines whether to enter the intersection based on the priority. The control unit 12 performs the travel control of entering and passing through the intersection in accordance with the determination result of the determination unit 11. As a result, the priority of the host vehicle can be set in accordance with the situation at the intersection which is designated to require vehicles on all road segments entering the intersection to stop at the same priority, and thus the travel control can be appropriately performed.

When there is a stopped vehicle that has stopped earlier at the intersection, the determination unit 11 outputs the determination result of entering the intersection later than the stopped vehicle. For example, the determination unit 11 sets the value of the priority of the host vehicle to be larger than that of the stopped vehicle. As a result, the stopped vehicle that has stopped earlier at the intersection can pass with priority, and traffic at the intersection can be performed smoothly according to the situation.

The determination unit 11 waits for the other vehicle, whose value of the priority is the minimum value, to pass through the intersection, reduces the value of the priority upon recognizing that the other vehicle has passed the intersection, and outputs the determination result of entering the intersection when the value of the priority becomes the minimum value. At this time, after waiting for the other vehicle which has the highest priority order to pass through the intersection, the priority order of the host vehicle is increased by one, and such processing is repeatedly performed until the priority order becomes the first priority. When the value of the priority of the host vehicle is the minimum value (first priority order), control is performed to enter the intersection. As a result, the vehicle which has a higher priority order can pass the intersection with priority, and each vehicle can pass in an appropriate order according to the situation.

The determination unit 11 outputs the determination result of entering the intersection when there is no other stopped vehicle stopped at the intersection. For example, when there is no other stopped vehicle, the determination unit 11 sets the value of the priority to the minimum value. As a result, when there is no stopped vehicle which has stopped earlier, the priority of the host vehicle is set to be the first priority, and appropriate travel control can be performed according to the situation and in accordance with a rule that the vehicles which have stopped earlier are prioritized.

The determination unit 11 determines whether there is any simultaneous arriving vehicle which has stopped simultaneously at the intersection within a predetermined period. When there is a simultaneous arriving vehicle, the determination unit 11 outputs the determination result of entering the intersection later than other stopped vehicles including the stopped vehicle that has stopped earlier at the intersection and the simultaneous arriving vehicle located between the host vehicle and the stopped vehicle in the priority direction. For example, the determination unit 11 sets the value of the priority of the host vehicle to be larger than the other stopped vehicles including the stopped vehicle that has stopped earlier at the intersection and the simultaneous arriving vehicle located between the host vehicle and the stopped vehicle in the priority direction. For example, in the case of the right-hand traffic, the vehicle located on the right side is prioritized, and in the case of the left-hand traffic, the vehicle located on the left side is prioritized. As a result, when there is a simultaneous arriving vehicle at the intersection, the stopped vehicle which has stopped earlier and the vehicle that is located between the host vehicle and the stopped vehicle in the priority direction (the right side in the case of the right-hand traffic and the left side in the case of the left-hand traffic) are prioritized, and traffic at the intersection can be performed smoothly according to the situation.

The determination unit 11 sets the priority indicating the priority order of passing through the intersection, and determines whether to enter the intersection based on the priority. When there is a simultaneous arriving vehicle and there are stopped vehicles in all road segments of the intersection, the determination unit 11 waits for another vehicle whose value of the priority is the minimum value to pass through the intersection. Upon recognizing that the other vehicle has passed the intersection, the determination unit 11 sets the value of the priority of the host vehicle to be larger than the other stopped vehicles including the stopped vehicle that has stopped earlier at the intersection and the simultaneous arriving vehicle located between the host vehicle and the stopped vehicle in the priority direction. At this time, when there is a simultaneous arriving vehicle at the intersection and there are stopped vehicles in all directions, the determination unit 11 waits for the other vehicle whose priority order is the highest to pass through the intersection. Then, the priority is set such that the stopped vehicle which has stopped earlier and the vehicle that is located between the host vehicle and the stopped vehicle in the priority direction (the right side in the case of the right-hand traffic) are prioritized. As a result, when the vehicles are stopped in all directions at the intersection while there are simultaneous arriving vehicles, the vehicle stopped earlier can be prioritized, and the vehicle located in the priority direction among the simultaneous arriving vehicles can pass with priority, thus each vehicle can pass in an appropriate order according to the situation.

The determination unit 11 determines whether there is any vehicle passing in the intersection, and outputs the determination result of entering the intersection when there is no other vehicle in the intersection. The control unit 12 starts the traveling for passing the intersection in accordance with the determination result of entering the intersection determined by the determination unit 11. As a result, the host vehicle can enter and pass the intersection since it is confirmed that there is no passage of other vehicle, thus overlapping of passage of the intersection of a plurality of vehicles can be prevented. Therefore, each vehicle can pass smoothly in the intersection.

The determination unit 11 determines whether there is any simultaneous arriving vehicle stopped at the intersection simultaneously within the predetermined period, and uses the random number to set the predetermined waiting time when there are simultaneous arriving vehicles at all road segments of the intersection. The determination unit 11 confirms whether another vehicle enters the intersection after the waiting time has elapsed, and outputs the determination result of entering the intersection when the other vehicle does not enter. At this time, when there are simultaneous arriving vehicles in all directions of the intersection, each vehicle uses a random number to set a random waiting time and waits, so that timing for each vehicle to enter the intersection can be staggered without overlapping, and each vehicle can thus pass sequentially. Therefore, a case where a plurality of vehicles enter the intersection simultaneously can be prevented, and each vehicle can pass smoothly. In this case, even when there are vehicles that do not have vehicle-vehicle communication and road-vehicle communication functions, or when there are manually-driven vehicles, the timing for each vehicle to enter the intersection can be arbitrated to reduce simultaneous passage.

The determination unit 11 sets the waiting time such that the waiting time in the case where the host vehicle travels straight through the intersection is shorter than the waiting time in the case where the host vehicle turns right or turns left. As a result, a vehicle which is to travel straight can pass with priority and each vehicle can thus smoothly pass in an appropriate order according to the situation. In the case of the right-hand traffic, the vehicles are prioritized in the order of traveling straight—right turn—left turn. In the case of the left-hand traffic, the vehicles are prioritized in the order of traveling straight—left turn—right turn, so that passage of each vehicle at the intersection can be more appropriately controlled.

The determination unit 11 determines whether there is any other moving vehicle at the intersection, and stops the traveling and sets the waiting time again when there is another moving vehicle. As a result, even when a plurality of vehicles attempts to enter the intersection, overlapping of passage of the intersection of the plurality of vehicles can be prevented, and each vehicle can thus pass smoothly.

Although various embodiments are described above with reference to the drawings, it is needless to say that the present disclosure is not limited to such examples. It will be apparent to those skilled in the art that various alterations, modifications, substitutions, additions, deletions, and equivalents can be conceived within the scope of the claims, and it should be understood that such changes also belong to the technical scope of the present disclosure. Each component in the various embodiments mentioned above may be combined arbitrarily in the range without deviating from the spirit of the invention.

The present disclosure is useful as a vehicle control device, a vehicle control method, and a program which can appropriately control traveling of a vehicle according to situations at an intersection whose entries all have the same priority.

This application is based on and claims priority from Japanese Patent Application No. 2019-068794 filed on Mar. 29, 2019, the entire contents of which are incorporated herein by reference.

1. A vehicle control device configured to control traveling of a vehicle which can be automatically driven, the vehicle control device comprising:
a determination unit configured to determine a control condition related to vehicle traveling when a host vehicle, which is a control target vehicle, travels automatically by automatic driving; and
a control unit configured to control traveling of the host vehicle based on a determination result of the determination,
wherein the determination unit is configured to:
acquire a position of the host vehicle; and
determine whether to enter an intersection based on a detection result of a stopped vehicle stopped at the intersection when the host vehicle approaches the intersection which is designated to require vehicles on all road segments entering the intersection to stop at a same priority, and
wherein the control unit is configured to perform travel control of entering and passing through the intersection in accordance with a determination result of the determination unit.

2. The vehicle control device according to claim 1, wherein the determination unit is configured to set a priority indicating a priority order of passing through the intersection, and determine whether to enter the intersection based on the priority.

3. The vehicle control device according to claim 1, wherein when there is a stopped vehicle that has stopped earlier at the intersection, the determination unit is configured to output a determination result of entering the intersection later than the stopped vehicle.

4. The vehicle control device according to claim 2, wherein the determination unit is configured to:
wait for another vehicle, whose value of the priority is a minimum value, to pass through the intersection, and reduce a value of the priority upon recognizing that the another vehicle has passed the intersection; and
output the determination result of entering the intersection when the value of the priority is the minimum value.

5. The vehicle control device according to claim 1, wherein the determination unit is configured to output a determination result of entering the intersection when there is no other stopped vehicle stopped at the intersection.

6. The vehicle control device according to claim 1, wherein the determination unit is configured to:
determine whether there is any simultaneous arriving vehicle stopped at the intersection simultaneously within a predetermined period; and
output, when there is a simultaneous arriving vehicle, a determination result of entering the intersection later than other stopped vehicles including a stopped vehicle that has stopped earlier at the intersection and the simultaneous arriving vehicle located between the host vehicle and the stopped vehicle in a priority direction.

7. The vehicle control device according to claim 1, wherein the determination unit is configured to:
set a priority indicating a priority order of passing through the intersection, and determine whether to enter the intersection based on the priority; and
wait, when there is a simultaneous arriving vehicle stopped at the intersection simultaneously within a predetermined period and there are stopped vehicles on all road segments entering the intersection, for another vehicle, whose value of the priority is a minimum value, to pass through the intersection, and set a value of the priority of the host vehicle to be larger than other stopped vehicles including a stopped vehicle that has stopped earlier at the intersection and the simultaneous arriving vehicle located between the host vehicle and the stopped vehicle in a priority direction upon recognizing that the another vehicle has passed the intersection.

8. The vehicle control device according to claim 7, wherein the determination unit is configured to:
wait for the another vehicle, whose value of the priority is the minimum value, to pass through the intersection, and reduce the value of the priority upon recognizing that the another vehicle has passed the intersection; and
output a determination result of entering the intersection when the value of the priority is the minimum value.

9. The vehicle control device according to claim 3, wherein the determination unit is configured to further determine whether there is any vehicle passing in the intersection, and outputs the determination result of entering the intersection when there is no other vehicle in the intersection, and
wherein the control unit is configured to start traveling for passing the intersection in accordance with the determination result of entering the intersection determined by the determination unit.

10. The vehicle control device according to claim 1, wherein the determination unit is configured to:
determine whether there is any simultaneous arriving vehicle stopped at the intersection simultaneously within a predetermined period; and
use a random number to set a predetermined waiting time when there are simultaneous arriving vehicles at all road segments entering the intersection, confirm whether another vehicle enters the intersection after the waiting time has elapsed, and output a determination result of entering the intersection when the other vehicle does not enter.

11. The vehicle control device according to claim 10, wherein the determination unit is configured to set the waiting time such that a waiting time in a case where the host vehicle travels straight through the intersection is shorter than a waiting time in a case where the host vehicle turns right or turns left.

12. The vehicle control device according to claim 10, wherein the determination unit is configured to determine whether there is any other moving vehicle at the intersection, and stop traveling and set the waiting time again when there is the moving vehicle.

13. A vehicle control method of a vehicle control device configured to control traveling of a vehicle which can be automatically driven, the vehicle control method comprising:
determining a control condition related to vehicle traveling when a host vehicle, which is a control target vehicle, travels automatically by automatic driving; and
controlling traveling of the host vehicle based on a determination result of the determination,
wherein the determining the control condition comprises:
acquiring a position of the host vehicle; and
determining whether to enter an intersection based on a detection result of a stopped vehicle stopped at the intersection when the host vehicle approaches the intersection which is designated to require vehicles on all road segments entering the intersection to stop at a same priority, and
wherein the controlling traveling of the host vehicle comprises:
performing travel control of entering and passing through the intersection is performed in accordance with a determination result of whether to enter the intersection.

14. A non-transitory computer-readable medium storing a program, when executed by a computer, causing the computer to perform a vehicle control method for controlling traveling of a vehicle which can be automatically driven, the method comprising:
determining a control condition related to vehicle traveling when a host vehicle, which is a control target vehicle, travels automatically by automatic driving; and
controlling traveling of the host vehicle based on a determination result of the determination,
wherein the determining the control condition comprises:
acquiring a position of the host vehicle; and
determining whether to enter an intersection based on a detection result of a stopped vehicle stopped at the intersection when the host vehicle approaches the intersection which is designated to require vehicles on all road segments entering the intersection to stop at a same priority, and
wherein the controlling traveling of the host vehicle comprises:
performing travel control of entering and passing through the intersection in accordance with a determination result of whether to enter the intersection.
